(19) United States
(12) Patent Application Publication
(10) Pub. No.: US 2025/0020258 A1
(43) Pub. Date: Jan. 16, 2025

(54) A METHOD AND APPARATUS FOR JOINING HOLLOW STRUCTURES

(71) Applicant: LONG PIPES LIMITED, Cockburn Central, Western Australia (AU)

(72) Inventor: Neil Deryck Bray GRAHAM, Coogee, Western Australia (AU)

(73) Assignee: LONG PIPES LIMITED, Cockburn Central, Western Australia (AU)

(21) Appl. No.: 18/713,440

(22) PCT Filed: Nov. 24, 2022
(86) PCT No.: PCT/AU2022/051408

§ 371 Date: May 24, 2024

(30) Foreign Application Priority Data
Nov. 24, 2021 (AU) 2021903796

(51) Int. Cl. F16L 47/12; F16L 47/02; F16L 47/06

(52) U.S. Cl. CPC F16L 47/12; F16L 47/02; F16L 47/065

(57) ABSTRACT

A method for joining two pipe sections of laminate structure and having an inner liner, comprising the steps of: (a) connecting a first pipe section to a first connection member to form a first assembly; (b) disposing the first assembly within a sleeve with a space disposed between an outer surface of the first pipe section and an inner surface of the sleeve; (c) optionally connecting the sleeve to the first assembly; (d) providing a second pipe section with a second connection member joinable with the first connection member; (e) moving the second pipe section and the first assembly towards each other; and (f) connecting the second pipe section to the first assembly through joining the second connection member to the first connection member to form a joint, the inner liner of both the first and second pipe sections being locked within the joint.

### TECHNICAL FIELD

The present invention relates to a method and apparatus for joining hollow structures. Such hollow structures may include pipes and through fittings, such as elbows and T and Y fittings. Such hollow structures may also include other items-such as end domes or other modules—to construct process vessels and tanks. Hollow structures may also be used as components to other civil construction, for example in the construction of bridges piers and jetties.

### BACKGROUND ART

The following discussion of the background art is intended to facilitate an understanding of the present invention only. The discussion is not an acknowledgement or admission that any of the material referred to is or was part of the common general knowledge as at the priority date of the application.

It is known to construct pipes using fibre-reinforced plastic composites. Typically, such pipes are constructed by a process in which rovings of filaments of fibre material, (such as glass fibres) are impregnated with a thermosettable resin or thermoplastic composition.

The Applicant has, as described in U.S. Pat. No. 9,435,468 and International Publication WO2017185143, the contents of which are hereby incorporated herein by reference, devised a pipe or hollow structure which can be constructed to comprise a radially inner portion and a radially outer portion, with the two portions merging together to provide an integrated tubular wall structure through a method further comprising: providing the radially inner portion; assembling the radially outer portion about the radially inner portion; and expanding the inner portion; wherein the outer portion comprises an outer tube of fibre reinforced composite construction surrounded by a flexible outer casing. Preferably, the outer tube of fibre reinforced composite construction comprises reinforcement and a binder. The binder preferably comprises a settable plastic, such as a resinous binder or resin. The binder sets to a resin matrix for binding the layers of reinforcing fabric together and to bind the reinforcement to the inner portion to provide the integrated tubular wall structure. This is described in the Applicant's U.S. Pat. No. 9,435,468 and International Publication WO2017185143. The resin matrix may also bind the reinforcement to the outer casing.

Hollow structures, typically pipes, are constructed in lengths as described above. Though long lengths of pipe can be constructed, as disclosed in U.S. Pat. No. 9,435,468, such lengths of pipe or pipe sections are likely to require joints or joining together at some point, noting that the joints may cause areas of weakness in structural integrity in a constructed pipeline.

Jointing of pipe sections, as currently conducted through a range of potential techniques all of which involve deficiencies in the context of time and cost requirements for constructing lengthy pipelines, particularly on a continuous basis, is not a simple task. One jointing technique involves grinding of the ends of the pipe sections to be jointed together at shoulder or screw sections so that the pipe section's interference fit within each other enables them to be joined together by an adhesive method. Such grinding requires precision and judgment about joint geometry and this is cumbersome, difficult and unsafe to the extent that dust is generated during grinding. Grinding is also time consuming and expensive. A further issue is that this jointing method tends to leave the edges of the pipe exposed to attack by materials being transported which can lead to delamination of an inner layer or liner of the pipe. In the case of gases, and particularly hydrogen, a gap may be left between the liner and pipes which are conventionally joined encouraging leaks and a leak path around the liner. This leak path could present significant issues where gases and other fluids are transported.

Further, such joints as are produced involving grinding (though the following is also true of other jointing methods), are subject to regular structural failure due to the difficulty of assembly. This is particularly so if a “scrape” or a line is left in the adhesive which provides a leak path for the fluids (liquid or gas) to escape and/or there is a tendency for the materials in contact with the fluids being transported to rapidly break down. Such assembly is also not amenable to continuous production, for example through an assembly line process.

Other known jointing methods use metal end fittings and complex metal wedging arrangements, some of which require bolts and screws to be used in jointing. This is also a potentially time-consuming operation and also difficult to automate. Fabrication of metal pipes is also potentially expensive, particularly if specialty alloys are required, noting that hydrogen embrittlement would be a potential issue for a metal pipe used to convey hydrogen. Ability to automate the jointing process is expected to be a necessity to handle long distance composite pipeline projects where the pipeline is constructed from short sections of pipe that are transported separately to site.

It is against this background, and the problems and difficulties associated therewith, that the present invention has been developed.

### SUMMARY OF INVENTION

According to a first aspect of the invention, there is provided a method for joining two pipe sections of laminate structure, comprising the steps of:
(a) connecting a first pipe section having an inner liner to a first connection member to form a first assembly;
(b) disposing the first assembly within a sleeve with a space disposed between an outer surface of the first pipe section and an inner surface of the sleeve;
(c) optionally connecting the sleeve to the first assembly;
(d) providing a second pipe section having an inner liner with a second connection member joinable with the first connection member;
(e) moving the second pipe section and first assembly towards each other; and
(f) connecting the second pipe section to the first assembly through joining the second connection member to the first connection member to form a joint in which the first and second pipe sections are connected to each other and the sleeve, the inner liner of both the first and second pipe sections thus being locked within the joint. Steps (a) to (f) may be conducted in any practical order and, in some embodiments, steps may be conducted simultaneously.

Disposing the first assembly within the sleeve in step (b) conveniently comprises sliding the first pipe section inside the sleeve whether manually or, where pipe dimensions and weight require, as would be expected in industrial applications, automatically. Moving step (e) also conveniently involves sliding the second pipe section into the first assembly.

Following step (b), the first assembly may then be connected to the sleeve in step (c), conveniently by bonding or adhesion. Alternatively, the first assembly and second pipe section may be connected to the sleeve in step (f). Connection between sleeve and first assembly may also be made between the first connection member and the sleeve. In some preferred embodiments, steps (a) to (c) may be conducted in a factory environment to facilitate secure bonding of: 1) first pipe section to first connection member to form the first assembly, and 2) first assembly to the sleeve and greater assurance over later fabrication steps which would typically involve significant forces, for example several tonnes of force, particularly in steps (e) and (f).

Conveniently, the first and second pipe sections have a generally circular section being of cylindrical or elliptical geometry. Some minor imperfections of geometry may occur dependent on the fabrication technique used. In such case, the first and second connection members conveniently fit around a circumference of the respective first and second pipe section, conveniently at one end of the respective first and second pipe sections. First and second connection members could themselves be formed into plural connection members though this may not improve ease of assembly. Optionally, first or second connection members could be formed integrally with a respective pipe section.

The first and second connection members, which are of material to tolerate the materials to be transported through the pipe sections, are provided with a connection means to connect to the respective pipe sections. A convenient connection means is a slot which engages with an end of a pipe section, for example a tongue and groove type connection. The first and second connection members should be sufficiently flexible to allow connection, through flexing and fitting, to the first and second pipe sections. However, excessive flexibility of the first and second connection members could interfere with formation of the first and second assemblies in embodiments as described below. When positioned and connected to the respective first and second pipe sections, the respective first and second connection members also protect the pipe section ends at the joint; thus, the first and second connection members lock the liner into the joint, minimising the risk of delamination or peeling and other damage that could lead to gaps and leak paths. The first and second connection members are desirably bonded to ends of the pipe sections, desirably by adhesion or thermal welding. It may also be advantageous to corona or plasma etch the surfaces of the end of each pipe section to enhance bonding or welding of respective connection member and respective pipe section.

The first and second connection members, conveniently extrusions, may have additional extensions to the extrusion or as part of the extrusion to provide a flexible low modulus area in the joint to accommodate movement of the pipe sections within the sleeve without failure of the adhesive interface on the sleeve lock. The first and second connection members are desirably pre compressed to accommodate movement in the joint without integrity failure at the interface of the liner lock.

The first and second connection members should have complementary geometry to facilitate jointing. For example, the first connecting member may have a flat portion which—when the first connecting member is connected to the first pipe section—extends outward from the first pipe section. This flat portion may be rippled or corrugated to provide flexibility for the flat portion. Such a flat portion leaves a space disposed between the inner surface of the sleeve and the flat portion. In one embodiment, the flat portion is provided with an upstanding wall portion extending outward from the flat portion, desirably at an acute angle to the flat portion. The upstanding wall portion is also flexible and movable upward by the second connection member when acting against it as a piston as described below. The upstanding wall portion may be omitted in other embodiments.

The second connection member conveniently has a geometry that allows jointing with the first connection member through accommodation within the space between the inner surface of the sleeve and the flat portion. The space may, for example, be annular and of part cylindrical geometry for cylindrical pipe sections, though other complementary joint geometries configured to pipe section geometry are not precluded. The second connection member may be provided with a single wedge portion to fit within the space between the inner surface of the sleeve and the flat portion. The wedge portion may be extended to form a nose or a bevelled, chamfered or rounded head which, when employed, assists in moving the upstanding wall portion of the first connection member. Such an extended wedge portion may also assist its accommodation within the space between the flat portion of the first connection member and the inner surface of the sleeve. Whatever the geometry, the second connection member joins with the first connection member to facilitate jointing between the first and second pipe sections.

Each of the first and second connection members are desirably provided with means, preferably selected from cuts or slots or valleys or ripples, for distributing adhesive axially—that is along the outer surfaces of the pipe sections-into the space disposed between the inner surface of the sleeve and the outer surfaces of the pipe sections and away from the inside of the pipe sections as described below. The cuts or slots may be formed during the jointing process or during fabrication of the first and second connection members. Feet formed by the cuts or slots also assist in steps (e) and (f) as described below. The flat portion—and in preferred embodiments the upstanding wall portion of the first connection member-co-operate with the wedge portion of the second connection member to distribute adhesive away from the inside surfaces of the pipe sections.

Though the first and second connection members could possibly allow an interference fit, noting that this may not be sufficient to prevent formation of a potential gas leakage path, connection in step (f) preferably involves adhesion or bonding together of the first and second connection means, typically through a suitable adhesive which may, for example, be applied to the first connection member prior to step (e) above. Where the pipe is circular, adhesive is conveniently and desirably applied around the circumference of the space of the first connection member as well as to the second connection member. In other embodiments, thermal welding may be an alternative.

Desirably, the first connection member, when connected to the first pipe section in step (a), is configured to enable the second pipe section to be centralised or aligned co-centrically with the sleeve conveniently through location of the second connection member and its associated second pipe section in the space disposed between the flat portion of the first connection member and the sleeve. The above-described feet, in particular of the second connection member, also assist in connection through providing the capacity to flex into position and reduce risk of damage to the second connection member during the jointing step. Prior jointing techniques have not enabled such alignment and centralisation with the result that adhesives used in forming the joint have tended to flow away from the joint through gaps left through a non-centralised assembly in which first and second pipe sections are not aligned. With centralisation or alignment of the first and second pipe sections, this loss or waste of adhesive and consequent leak path is prevented whilst a more even distribution of adhesive can be achieved. Most importantly, this ensures that the pipe and the sleeve are aligned in a basically dry state and then the pipe is centralised within the sleeve so as the sleeve is acting as a jig to align centralise and lock the pipe within the joint.

As to connection of the sleeve to each of the first and second pipe sections, this step conveniently proceeds as follows. The sleeve has a greater inner diameter than the outer diameter of each of the pipe sections so that there is a space between the outer surface of each pipe section and the inner surface of the sleeve. A spacer or wedge may be fitted into this space to close either—with an optional exception as described below—an opening to the space between an end of the sleeve and each of the first and second pipe sections. One spacer or wedge, which may also be referred to as an external wedge is conveniently provided to close the opening to the space between the first pipe section and the sleeve though this operation may, in preferred embodiments, be conducted in a factory setting along with steps (a) to (c) and for the same reasons as provided above. Another spacer or wedge, as a short wedge of material (i.e. of lesser length than the sleeve) or as an extended wedge to cover anything up to the full length of the sleeve, is conveniently provided for fitting to close the opening to the space between the second pipe section and the sleeve resulting in an enclosed space. This wedge may be fitted in a factory or in field setting. Such fitting of wedge into the space also assists with centralisation of pipe sections at the joint minimising the possible formation of gaps through which leaks could occur. The sleeve may have chamfered ends to assist with fitting of the wedge, the chamfer conveniently being at the same angle as the slope of a surface of the wedge.

Each spacer or wedge is conveniently a strip of material that has sufficient dimension to fit within the space, desirably forming a mechanical lock during the compression step described below. The spacer or wedge may be thin and have a length which is a substantial proportion of the length of the sleeve. Insertion of the spacer or wedge also helps to position the sleeve and each pipe section so that the space between sleeve and pipe sections is annular. The annular space is, by the use of the wedge, desirably of substantially uniform dimension to enhance uniform adhesive flow so that it moves evenly around the annulus to join at the top of the sleeve and pipe assembly to expel the air from the space. With this arrangement, the annular space should be filled evenly, consistently and reliably minimising the probability of formation of potential leak paths and voids.

The wedge also provides a closure for the joint with a material that is under high levels of compression and the adhesive is compressed into the joint. This compression results in a tough peel resistant point that will not peel easily. This is very different to other joint designs where the end of the joint is just bare adhesive that is prone to peel.

The spacer or wedge may conveniently be formed in the shape of an aerofoil, with the narrow end fitted into each opening to the space between the inner surface of the sleeve and the outer surface of each pipe section to form an enclosed space. As with the first and second connection members, a degree of flexibility of the spacer or wedge may facilitate assembly. However, excessive flexibility may allow twisting during assembly and this is undesirable as it may prevent a lock liner to lock liner joint as described further below.

Alternatively, the spacer or wedge may be joined or formed integrally with each pipe section.

Moving the second pipe section into the first assembly—and forming the required joint—involves compression of the second pipe section towards the first assembly. The degree of compression is desirably adjustable. An adjustable clamping mechanism, such as a strap or cable tensioner or winch, may be used for this purpose with clamping elements conveniently bearing against shoulder(s) formed by the sleeve ends of the first pipe. Compression also assists in locking the internal wedge(s) between inner surface of the sleeve and outer surface of the second pipe section to form an enclosed space in a preferred embodiment.

In such a preferred embodiment, a first wedge between inner surface of the sleeve and outer surface of the first pipe section has already been driven and compressed into position also using a clamping mechanism, and then a drive mechanism such as a screw jack mechanism is used to drive in the external wedge.

Returning to jointing of the first and second pipe sections, the clamping mechanism preferably allows for the degree of compression to be adjusted. Desirably, the wedge between the inner surface of the sleeve and the outer surface of the second pipe section is not locked into position until a compression operation for moving the second pipe section towards the first pipe assembly is complete, conveniently as determined by a resistance or stopping of easy movement of second pipe section towards the first assembly. This step may also be conducted in embodiments where wedges for each pipe section are locked into position at the same time.

The compression also causes the second connection member, entering the space between the flat portion and upstanding wall portion of the first connection member and the sleeve to act as a piston, with the space acting as the cylinder. The resultant pumping action results in distribution of adhesive across contacting faces of the first and second connection members and axially through slots in the first and second connection members into the space between the sleeve and first and second pipe sections so that gaps between the first and pipe sections are sealed with adhesive to avoid formation of leak paths whilst preventing access of adhesive to the inside of the joined pipe sections. As described above, the feet—formed between slots—allow the second connection member to flex into position during compression. The slots are also compressible, such that constriction may occur during this step, so dimension of the slots should be selected to avoid, during such compression, blocking and lack of flow of adhesive which is desired through all slots of the second connection member as well as the first connection member.

The above described geometry of the first and second connection members and, in particular, the wall portion of the first connection member minimises flow of adhesive towards the inner surfaces of the pipe sections, rather its compression and upward movement forcing adhesive towards the outer surfaces of the pipe section and, with the increased pressure, forming a stronger bond at a joint interface between the first and second joint members and other components of the joint as previously described. Sealing of leak paths is highly advantageous in any application but particularly a gaseous transport application, such as the transport of hydrogen or carbon dioxide according to a preferred embodiment of the present invention.

No post curing of the joint should be required due to the surface area achieved on the sleeve and pipe interface at the joint meaning that the adhesive in these areas are lightly loaded though heating of the pipe sections may be conducted to assist the assembly operation if needed.

This is highly desirable, as it assists in providing a leakproof joint with potential considerable strength, the method includes a step (g) substantially filling the enclosed annular space between the sleeve and first and second pipe sections with a sealing and adhesive material. A substantially uniform dimension of the now enclosed annular space, that is, the dimension between the inner surface of the sleeve and the outer surface of the first and second pipe sections, assists the filling process. The process of filling the enclosed space with a sealing and adhesive material is intended to remove air from the enclosed space and provides the joint with substantial surface area minimising the prospect of leaks and also adding strength at the joint such that the joint may have greater threshold for rupture than the pipe sections themselves. In preferred embodiments, the enclosed space between the inner surface of the first pipe section and inner surface of the sleeve is filled with sealing and adhesive material after the jointing of the first and second pipe sections for the reasons above described.

Though the space between sleeve and pipe sections is closed off by the wedges, it is desirable to leave some outlet between the enclosed space and exterior as this assists step (g) which also desirably involves the expulsion of air from the otherwise enclosed space. The spacer or wedge may also be selected to be of a length which leaves a gap. The sealing and adhesive material, which seals the joint, whilst also providing it with structural strength, is then injected into the space. The sealing and adhesive material is desirably a composite material, for example a polymer pulp such as Kevlar pulp, which may require addition of fibres, for example glass fibres and/or a thickening agent as well as a two component system where the first adhesive injected is one of very low viscosity followed by an adhesive of high viscosity. Or commercially available adhesives such as Plexus® acrylic methacrylate or Cresta Bond® Urethane or Sika Urethane, the adhesives being selected to suit the application. For example, different adhesives may be used dependent on whether the pipe is to carry water or wet carbon dioxide gas. The sleeve may be provided with injection port(s) to enable injection of the sealing and adhesive material. An injection port may be provided on the first pipe section side of the joint and another injection port may be provided on the second pipe section of the joint, desirably at a distance from the joint interface. In preferred embodiments, the space between sleeve, first pipe section and first connection member is filled with sealing and adhesive material in the factory at a different time from the joining operation.

The first and second pipe sections may be the same or different geometry, typically being of circular geometry. Each pipe section may comprise a length of pipe or a fitting, such as a T, Y or elbow, with the joints being formed on the various limbs of such fittings. The method can also be applied in the same way as for joining of pipe sections to joining of vessel sections, such as tank sections. In one embodiment, end domes of a process vessel may be connected to other portions of the process vessel or pressure tank by the method as above described. Modules for construction of a structure such as a bridge may also be joined together as described herein.

The pipe sections and sleeve are of laminated structure, conveniently being produced by the same process to form a fibre composite with inner liner, reinforcement layer and outer casing, although the sleeve has a greater inner diameter than the outer diameter of the pipe sections. A protective layer, such as a peel ply, may be applied on inner and or outer surfaces of the pipe sections and, also if desired, the sleeve to facilitate quick fabrication as the protective layer protects the bonding surface and minimises the need for preparatory work to provide a prepared surface ready for bonding and with the peel ply removal (where necessary) removes dust or contaminants such as dirt or grease that could impede the bond and address other flaws prior to forming the joint. Such protective layer may be removed prior to the joint fabrication as described above. Such protective layer is conveniently provided in a pipe section to be produced at or around the point of the joint, for example at a selected spacing made in a factory; or, when required in the field by adhering the peel ply layer to the outer casing where the joint is to be installed. In the case of the sleeve, the peel ply layer is conveniently provided between the inner liner and the reinforcement layer.

Although grinding is desirably avoided, for pipe sections having greater thickness, say having more than ten laminate layers of thickness, e.g. 10-20 mm, it may be desirable to grind surfaces at the joint interface to enable a space for, on injection of adhesive in one or a plurality of steps, a substantially uniform layer of adhesive at a complementary interface between the joined pipe sections. To achieve this, the pipe section edges may be ground having concentric layers at one or a plurality of steps. Sealing at a joint of such pipe sections may be achieved with adhesion at a section of the thickness of the pipe sections.

In a second aspect of the invention, there is provided a joint between two pipe sections of laminate structure, the joint comprising:
(a) a first joint portion comprising a first pipe section with an inner liner connected to a first connection member, said first joint portion being disposed within a sleeve with a space disposed between an outer surface of the first pipe section and an inner surface of the sleeve, the sleeve being connected to the first pipe section; and
(b) a second joint portion comprising a second pipe section with an inner liner with a second connection member joined to the first connection member at a joint interface and first pipe section, a space also being disposed between an outer surface of the second pipe section and an inner surface of the sleeve, the sleeve being connected to the second pipe section
   wherein the inner liner of the first and second pipe sections is locked within the joint. Desirably, following enclosure of the space between the sleeve, first and second pipe sections as described above, the enclosed space is substantially filled with a sealing and adhesive material as above described.

In a third aspect of the invention, there is provided an apparatus for joining two pipe sections of laminate structure, comprising:
(a) means for connecting a first pipe section having an inner liner to a first connection member;
(b) means for disposing a first assembly comprising the first pipe section connected to said first connection member within a sleeve with a space disposed between an outer surface of the first pipe section and an inner surface of the sleeve;
(c) optional means for connecting the sleeve to the first pipe section;
(d) means for providing a second pipe section having an inner liner with a second connection member joinable with the first connection member;
(e) compression means for moving the second pipe section and first assembly towards each other such that the second connection member joins with the first connection member; and
(f) means for joining the second pipe section to the first assembly to form a joint in which the first and second pipe sections are connected to the sleeve, under compression, the inner liner of both the first and second pipe sections being locked within the joint.

Highly desirably, as it assists in providing a leakproof joint, the apparatus includes an injection means for filling a space between the sleeve and a pipe section at the joint with a sealing and adhesive material as described above.

An advantage of the above method, joint and apparatus for joining pipe sections is the achievement of the locked liner to locked liner joints, i.e. the liner is locked within the joint, which ensures that—with the exception of portions of the first and second connection members-only the inner liner of the joined pipe sections is in contact with the materials being transported. The inner liner is the inner layer of the radially inner portion of each laminated pipe section. Locking the inner liner within the joint and, specifically within the first and second connection members is expected to avoid delamination or release of the inner liner from the joint. At the same time, the method is quicker (potentially less than 5 minutes per joint), easier and safer to perform without difficult precision work and in thin section pipe no machining being required by personnel forming a significant number of joints over a pipeline that may extend a substantial distance, potentially hundreds of kilometres. This also enables less requirement for specialised labour when joining pipe sections together and allows easier adaptation to an assembly line where each joint may be completed in less than 2 minutes. The method conveniently allows the pipe to be cut off roughly, i.e. without the precision necessary in grinding methods and does not require accurate machining in thin wall section pipes.

The method is also tolerant of inaccuracies in pipe and sleeve size and does not require the use of metal fittings.

### BRIEF DESCRIPTION OF THE DRAWINGS

Further features of the method and apparatus for joining hollow structures of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying schematic drawings (not to scale) in which:

FIG. 1 is a: schematic cross section of a pipe section to be joined to another pipe section according to an embodiment of the method of the present invention.

FIG. 1A is a schematic view of reinforcing fabric incorporating reinforcement fibres featuring quadraxial fibre orientations used in reinforcement of the outer layer of FIG. 1.

FIG. 2 is a schematic sectional view of a first assembly of a first pipe section and a sleeve connected to the first pipe section according to an embodiment of the present invention.

FIG. 3A is a schematic detail sectional view of the first assembly of FIG. 2.

FIG. 3B is a schematic end view of the first assembly shown in FIG. 3A.

FIG. 4A is a schematic side view of the first connection member of FIGS. 2 to 3B.

FIG. 4B is a schematic orthogonal view of the first connection member of FIGS. 2 to 3B.

FIG. 4C shows a schematic side view of an alternative embodiment of the first connection member.

FIG. 5A is a schematic side view (not to scale) of a preferred embodiment of second connection member used in the method according to one embodiment of the present invention.

FIG. 5B is a schematic side view of an alternative embodiment of second connection member used in the method according to one embodiment of the present invention.

FIG. 6A is a schematic side section of a wedge used in the method according one embodiment of the present invention.

FIG. 6B is a schematic side section of an extended wedge used in a further embodiment of the present invention.

FIG. 7A is a schematic side view of a second pipe section connected to a second connection member being brought into joining relation with the first assembly at a first point in time.

FIG. 7B is a schematic side view of a second pipe section connected to a second connection member being brought into joining relation with the first assembly at a second point in time at a later stage than FIG. 7A.

FIG. 7C is a schematic side view of a second pipe section connected to a second connection member in joining relation with the first assembly at a later stage than FIGS. 7A and 7B.

FIG. 7D is a schematic detail side sectional view of the second pipe section connected to the second connection member being brought into joining relation with the first assembly at a later point in time than FIG. 7B and as the second connection member acting as a piston impacts a lip of the first connection member.

FIG. 8 is a schematic end view of the second pipe section connected to the second connection member of FIGS. 7A to 7D in joining relation with the first assembly.

FIG. 9 is a schematic side view of the second pipe section connected to the second connection member and in joining relation with the first assembly as shown in FIG. 7C with a wedge in position.

FIG. 10 is a schematic side section view of the joint of the first and second pipe sections when the sleeve is wedged against the first and second pipe sections and the space between sleeve and pipe sections is filled with filling material.

FIG. 11 is a schematic orthogonal view showing the joint of FIG. 10 provided with a vent for release of air and excess sealing and adhesive material from the space between the sleeve and the second pipe section.

FIG. 12 is a side sectional schematic view of the wall of two pipe sections to be joined together according to a further embodiment of the present invention and in a spaced apart disposition.

FIG. 13 is a side sectional schematic view of the wall of the two pipe sections of FIG. 12 as they are moved together to form a joint according to the further embodiment of the present invention.

FIG. 14 is a detailed side sectional schematic view of the wall of the two pipe sections of FIGS. 12 and 13 as they are joined together.

FIG. 15 is a side sectional schematic view showing the relative disposition of the sleeve and assembly of FIG. 14

FIG. 16 is an exploded part sectional orthogonal schematic view showing the relative disposition of the assembly of FIGS. 14 and 15, sleeve and locking wedges.

FIG. 17 shows a part sectional orthogonal schematic view showing the relative disposition of the sleeve and locking wedges prior to the locking wedges being locked into position.

FIG. 18 shows the completed joint of the further embodiment of the present invention with sleeve locked into position by the locking wedges.

The drawings are not to scale.

### DESCRIPTION OF PREFERRED EMBODIMENTS

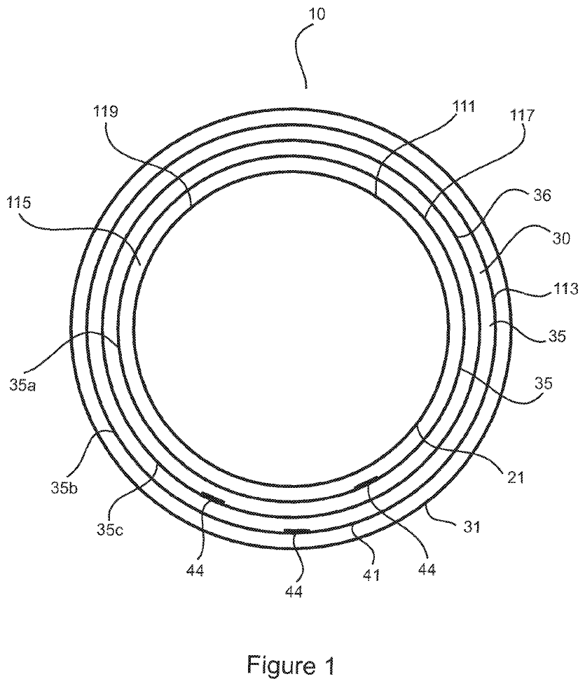

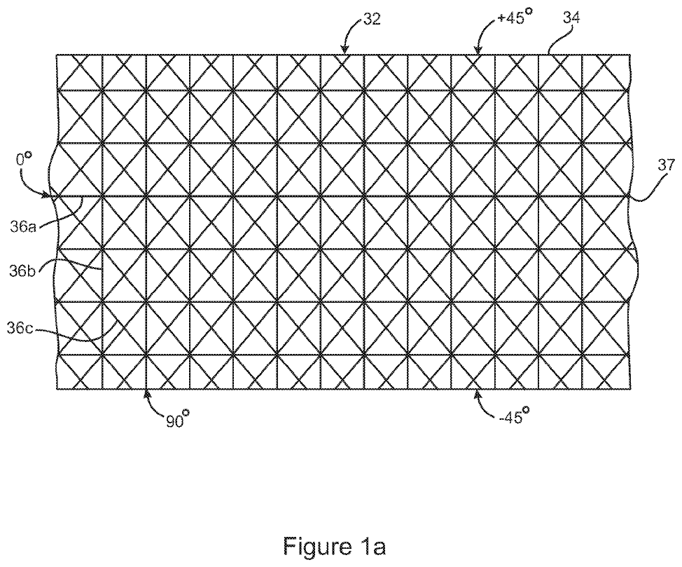

Referring to FIG. 1, there is shown a pipe 10 of composite construction and laminate structure, comprising a radially inner portion 111 and a radially outer portion 113, with the two portions merging together to provide an integrated tubular wall structure.

The inner portion 111 comprises an inner liner 115 with a layer 117 of resin absorbent material bonded onto one face thereof. The other face of the inner liner 115 defines the interior surface 119 of the pipe 10. Typically, the inner liner 115 presents a high gloss surface at the inner face 119. The inner layer 115 may, for example, comprise polyurethane, polyethylene, nylon or any other resiliently flexible material which is preferably also impervious to air (or other gases, including hydrogen which may be conveyed through pipe 10, and compatible with any other fluid that may be conveyed through pipe 10). Problems of hydrogen embrittlement as arise with steel and other metal alloys do not arise. The resin absorbent layer 117 may, for example, comprise felt, foam rubber, chopped strand mat (CSM) or any other suitable resin absorbent materials to promote and preserve a layer of excess resin to bond the liner to the finally formed pipe as described in the Applicant's U.S. Pat. No. 9,435,468 and International Publication WO2017185143, incorporated herein by reference.

The outer portion 113 is configured as an outer tube 30 of fibre reinforced composite construction surrounded by a flexible outer casing 31. More particularly, the outer tube 30 comprises tubular layers 35, each layer comprising reinforcing material such as reinforcing fabric 32, as shown in FIG. 1A, impregnated in a resinous binder. Each tubular layer 35 is formed from a strip of reinforcing material, as described in the Applicant's U.S. Pat. No. 9,435,468, incorporated herein by reference. The flexible outer casing 31 is installed around the tube 30 to contain the resinous binder, as will be described in more detail shortly. The flexible outer casing 31 may remain in place and ultimately form an integral part of the pipe 10, or it may be subsequently removed after having served its purpose, typically after the removal of any peel ply used to protect the pipe during transport.

The resinous material which provides the resinous binder may be of any appropriate type; particularly suitable resinous materials comprise thermosetting resins such as epoxy, vinyl ester, polyester acrylic or other suitable UV cured resin and thermoplastic resin systems.

The reinforcing material 32 comprises one or more layers of reinforcing fabric 34 (as shown in FIG. 1A), each layer being configured as a tubular layer 35 (as shown in FIG. 1) disposed about the inner tube 21. The pipe 10 includes a plurality of such tubular layers 35 and so a plurality of layers of reinforcing fabric 34. The reinforcing fabric 34 incorporates reinforcement fibres featuring quadraxial fibre orientations, as shown in FIG. 1A. The reinforcement fibres comprise axial fibres 36a (at an angle approaching the pipe axis 37), transverse fibres 36b (at an angle approaching 90 degrees to the pipe axis) and angular fibres 36c (at an angle approaching 45 degrees to the pipe axis 37). The reinforcement fibres may, for example, comprise fibreglass, aramid, basalt or carbon fibres or mixtures of these. The quadraxial fibre orientations offer the necessary hoop and axial stress bearing properties to pipe 10.

On inflation of inner tube 21, conveniently by air, as described in the Applicant's U.S. Pat. No. 9,435,468 incorporated herein by reference, the tubular layers 35 are stretched in all directions, serving to enhance hoop stress and axial stress bearing properties of pipe 10. Full inflation is highly desirable to maximise the stress bearing properties of pipe 10, in particular at the joint 200, 1200 as described below. In particular, the expansion serves to pre-stress fibres within the reinforcing fabric tubular layers 35 to enhance hoop stress bearing properties and also axially tensions the reinforcing fabric tubular layers to pre-stress fibres therein axially to enhance tensile load bearing properties of the pipe 10. The flexible outer casing 31 serves to resist radial expansion of the reinforcing fabric tubular layers 35, thereby causing the reinforcing material 32 to be subjected to radial compression.

The radially expanding inner tube 21 operates in conjunction with the flexible outer casing 21 to confine the reinforcing material 32 and also causes the volume of the space in which reinforcing material 32 is confined to progressively decrease. This forces the resinous binder within the reinforcing material 32 such that tubular layers 35 become fully “wetted-out”. In particular, it provides a compaction force to the reinforcing material 32 and effectively pumps the resinous binder through the tubular layers 35 in a controlled and constrained manner. During the wetting-out step, the resinous binder impregnating the reinforcing fabric 34 impregnates the layer of felt 117 on the inner liner 115 to integrate the outer portion 113 with the inner portion 111. At the same time, air is expelled from the space minimising the formation of air bubbles within the pipe wall. To the Applicant's knowledge, this results in a surprisingly strong light pipe with a 3 layer pipe recording 136 bar burst on a 350 mm pipe weighing less than 15 kg for 3 meters.

Suitable methods for manufacture of pipe 10 (and also the sleeve 40 as described below) include those described in the Applicant's U.S. Pat. No. 9,435,468, incorporated herein by reference for all purposes, and International Patent Publications WO 2017/205927 and WO 2017/205928, also hereby incorporated herein by reference for all purposes. Pipe 10 includes a protective layer, in the form of a peel ply layer at or around the point of the joint, for example at a selected spacing (for example, every 15 to 20 metres) when made in a factory; or, when required in the field by adhering the peel ply layer to the outer casing where the joint is to be installed. In the case of a pipe 10 to form the sleeve 40, the peel ply layer is conveniently provided between the inner liner 115 and the reinforcing fabric 34.

Pipe 10 may be produced by a pipe production machine (not shown) on a continuous basis in lengths, or hereon referred to as pipe sections, requiring jointing together to form a pipeline, for example to convey water or hydrogen gas. For example, the pipe 10 could be produced by the pipe production machine at a rate of 10 metres of pipe per minute for 1-10 kms in the field. Alternatively, pipe 10 could be produced in factory and cut into lengths, for example by a diamond tipped rotary saw or chain saw, an accurate 90 degree cut being desirable though not required where a jig holding the extrusion is designed to align the pipe with the extrusion and fill any remaining space with sealing and adhesive material. Where cutting is precise, less sealing and adhesive material is needed to fill any space between pipe sections 10, 60 as described below. Desirably, for joint strength, the filled space is minimised but this is not imperative as the joint area is large and supported, as described below by the sleeve 40 on the outside and the sealing and adhesive material in any space.

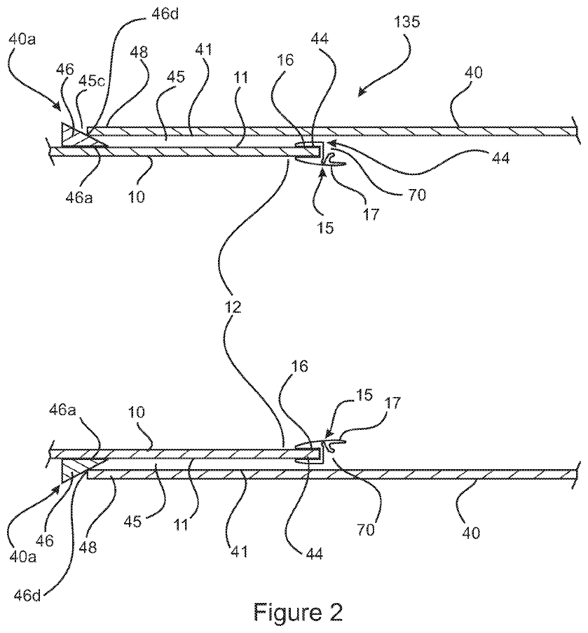

Referring now to FIGS. 2 to 10, there is schematically illustrated the connection of shown two pre-fabricated cylindrical pipe sections 10 and 60, each being fabricated, and having laminate structure as described above. First pipe section 10 is therefore identical to second pipe section 60 and, when joined together, the first and second pipe sections 10 and 60 are suitable for conveying a fluid such as a gas. Connection does not require the use of metal fittings and connection may be made in field or in a factory setting. It may be convenient for the pipe sections 10 and 60—as well as sleeve 40 described below—to be provided with a protective peel ply layer, on inside of the sleeve and/the outside of the pipe surfaces at the joint, for protection during transport and to enable easy and quick preparation for bonding operations. Such peel ply layer is removed in the location of the joint prior to the connection steps described below. One tool for removal of the peel ply layer has a portion—for example a blade—that can be forced under the peel ply layer at a location with rotation of the tool removing the peel ply layer.

First pipe section 10 is connected at its end 12 to a first connection member 15.

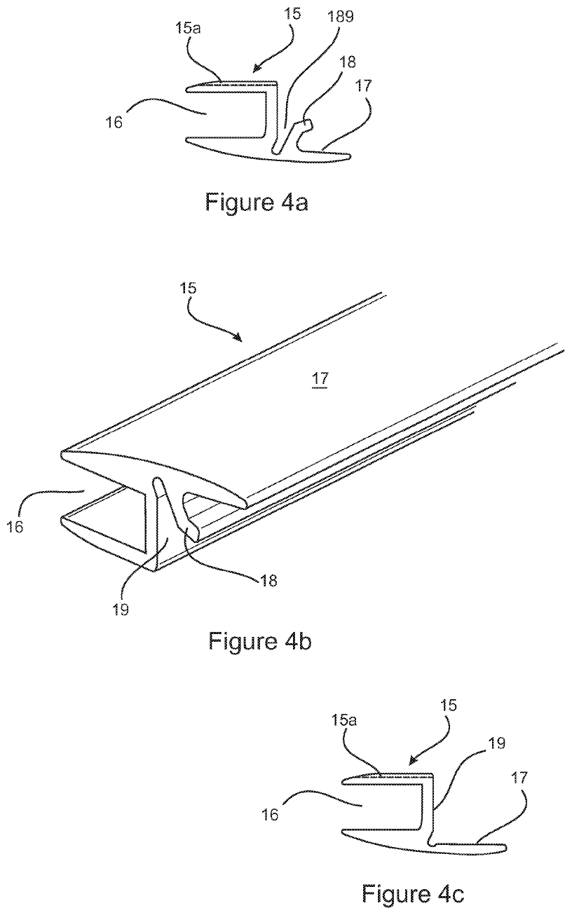

First connection member 15, as shown in FIGS. 4A and 4B (with an alternative embodiment being shown in FIG. 4C), is an extrusion with sufficient flexibility to be formed into a circular shape about the circumference of the end 12 of first pipe section 10 though it may be provided as a linear extrusion. A polymeric material, such as an elastomer selected for hydrogen or carbon dioxide transport, is a suitable material for first connection member 15. First connection member 15 has a slot 16 with an end wall 19 for engagement with the edge formed by pipe section end 12 and a flat portion 17 with a wall portion 18 extends in a direction away from the direction of the slot 16. Flat portion 17 has an upstanding wall portion 18 with a space 189 being disposed between the upstanding wall portion 18 and end wall 19. The first connection member 15 of FIG. 4C omits the upstanding wall portion 18 and may be used in other embodiments. First connection member 15 is also provided along its length or periphery (when fitted) with cuts or slots (shown in dashed outline as 15a) which function as described below.

The first connection member 15 is pressed into position about the circumference of the end 12 of first pipe section 10, the connection forming a first assembly 135. The first connection member 15 is bonded to end 12 of first pipe section 10 with adhesive as used in other steps of the method. Alternatively, a thermal welding method using an induction heating line in the first connection member 15 could be used. This seals the end 12 of first pipe section 10 which, when the joint is complete, ensures that materials being transported cannot access the joint or access the fibre reinforcement of the pipe section 10. It may be advantageous to corona or plasma etch the surfaces of the end 12 of pipe section 10 to enhance bonding or welding as the surfaces of the inner liner 115 are designed to stop materials sticking to them like condensate in a gas flow.

The first assembly 135 is disposed within a sleeve 40 with a space 45 disposed between an outer surface 11 of the first pipe section 10 and an inner surface 41 of the sleeve 40. The sleeve 40 facilitates the holding of pipe sections 10 and 60 in a desired alignment at the joint 200 and accommodates any differences, for example of up to 5 mm in 350 mm, in geometry or dimension between the two pipe sections 10 and 60. Depending on the diameter of the pipe section 10, the space 45 has a dimension of between 2 and 5 mm between outer surface 11 and inner surface 41 which allows for variations in the dimensions of pipe section 10 and sleeve 40. This dimension may be less for lesser diameter pipe sections and is minimised to minimise adhesive consumption as described below whilst maintaining the desired joint strength. The sleeve 40 is itself a laminate structure and fabricated as described above for first and second pipe sections 10 and 60. The sleeve 40 has ends 40a which form a shoulder or bearing surface for the joint steps described below. A suitable length for sleeve 40 in preferred embodiments is 1.5-2 times the outer diameter of each of pipe sections 10 and 60. Sleeve 40 may also be provided with an inner peel ply layer which is removed prior to the connection step described below.

The sleeve 40 is connected to the first assembly 135 as follows. A surface 44 of the sleeve 40, close to or correspondent with the area of connection, may be scuffed or roughened or plasma cleaned or etched to improve adhesive adhesion. Such scuffing is milder than, and to be contrasted with, a grinding process as formerly used. It may also be necessary to treat the surface 44 to remove residual release or blocking agent. Adhesive is applied to the sleeve 40 and/or the first assembly 135, to adhere to surface 44 such that the sleeve 40 and first pipe assembly 135 are bonded together. Wedge 46 is then fitted to close the space 45 between the inner surface 11 of pipe section 10 and sleeve 40 and sealing and adhesive material 45a is injected through an injection port (not shown) to complete the connection step. The configuration and fitting of wedges as well as the sealing and adhesive filling operation are described below and apply, as described, to fitting of wedge 46 as well as wedge 46A.

Preferably, where short pipes (for example up to 20 metres in length) are being produced, the above steps are conducted in a factory environment to facilitate secure bonding of: 1) first pipe section 60 to first connection member 15 to form the first assembly 135, and 2) first assembly 135 to sleeve 40 and greater assurance over later fabrication steps which would typically involve significant compression forces, for example several tonnes of force.

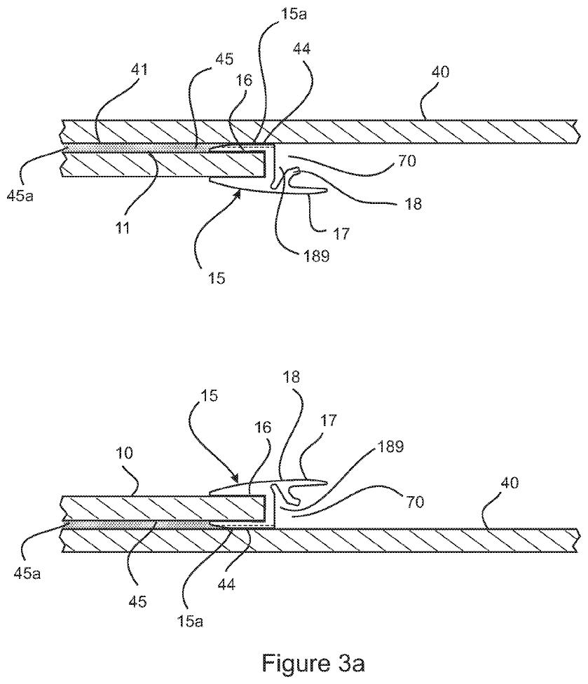

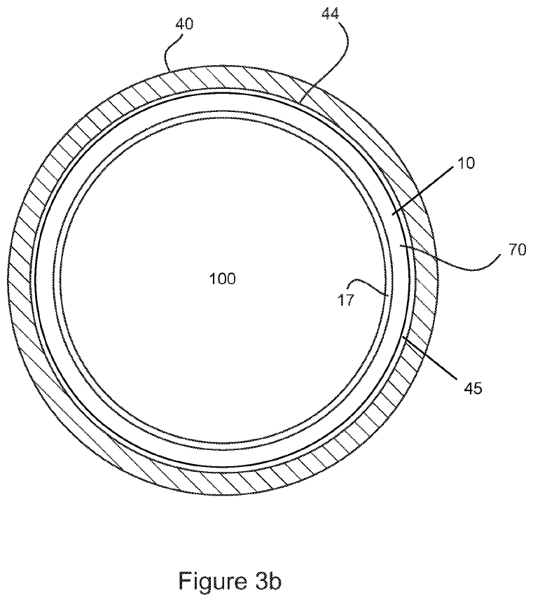

Following connection of sleeve 40 to first assembly 135, as shown in FIGS. 2 to 3B, an annular or part cylindrical space 70 is left between flat portion 17 and inner surface 41 of sleeve 40. Adhesive is injected throughout the annular space 70 in preparation for connection of first assembly 135 to second pipe section 60. The injection of adhesive may occur at a later time than connection of sleeve 40 to first assembly 135. The connection of sleeve 40 and first assembly 135 may also be fabricated at a location, for example a factory, remote from where the joint is to be formed, for example in-field. In this case, a Teflon or other suitable non stick plastic ring may be placed in annular space 70, this Teflon ring being removed prior to further steps in making the joint. Such Teflon ring is designed to fit into the space 189 and annular space 70 being held in position within slot by upstanding wall portion 18, at the same time maintaining the wall portion 18 in position without warping and keeps contaminants out of the annular space 70. If the Teflon ring is positioned during connection of sleeve 40 to first assembly 135, it prevents adhesive flowing into annular space 70 which could cause difficulties during connection of pipe sections 10 and 60. In such case, the Teflon ring could be provided with adhesive injection points around the ring so that the adhesive can be injected with the ring in position.

Second pipe section 60 has an end 62 which is connected to a second connection member 65 joinable with the first connection member 15. The second connection member 65 is pressed into position about the circumference of second pipe section 60 and bonded with similar or dissimilar adhesive as used in other steps of the method. Bonding proceeds in the same way as for first connection member 15 and pipe section 10 with plasma or corona etching being used to assist bonding as described above. Similarly to pipe section 10, this seals the end 62 of first pipe section 60 which, when the joint is complete, ensures that materials being transported cannot access the joint or access the fibre reinforcement of the pipe section 60.

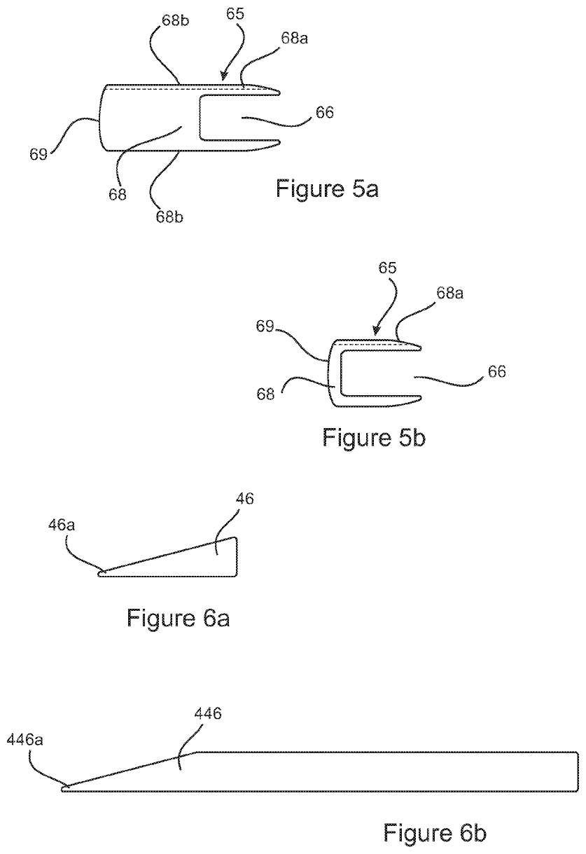

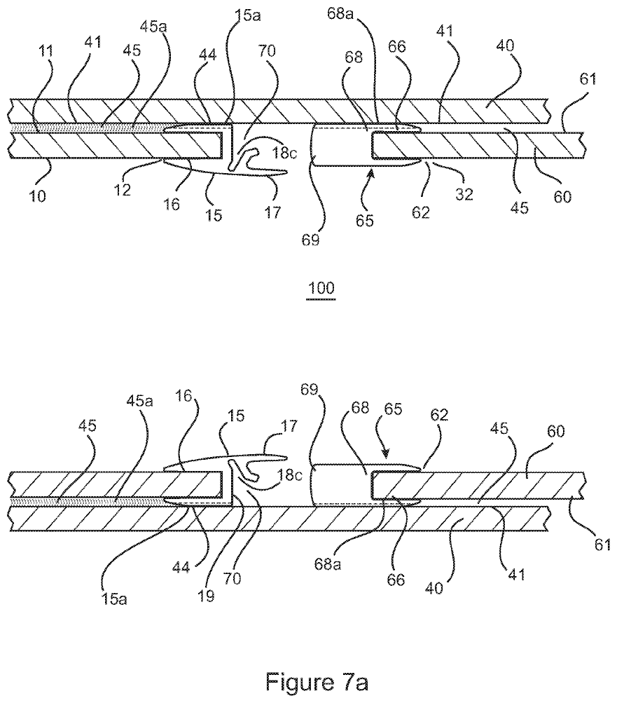

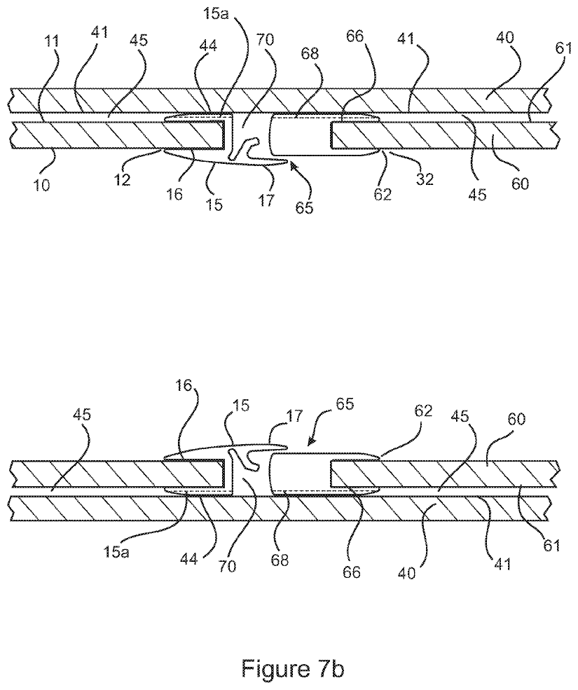

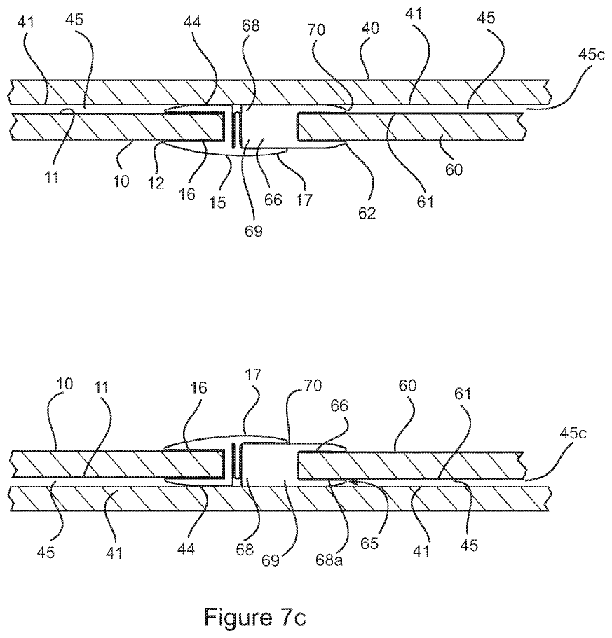

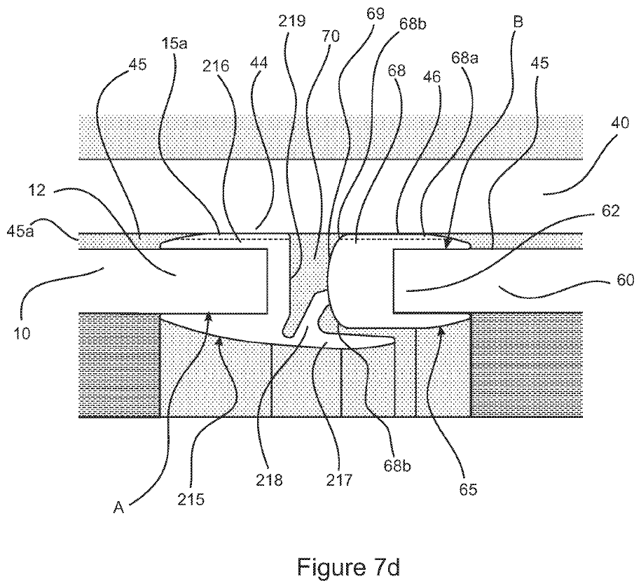

Referring to FIGS. 5A and 5B, second connection member 65, like the first connection member 15 and likewise selected of a material such as an elastomer suitable for the transport of hydrogen, carbon dioxide or any other material that could be transported in other embodiments, is an extrusion with sufficient flexibility to be formed into a circular shape and welded at the joint of the shape about the circumference of the end 62 of second pipe section 60 though it may be provided as a linear extrusion or an injection moulding specific for the size of the pipe section 60. A polymeric material, such as an elastomer, is a suitable material for the second connection member 50. Second connection member 65 has a slot 66 for engagement with the edge formed by end 62 of pipe section 60; and a rectangular section wedge portion 68 with an end wall 69 which extends in a direction away from the direction of the slot 66. Wedge portion 68 is complementary to, and joins with, the annular space between lip 17 and sleeve inner surface 41 as apparent from FIGS. 7 to 10. Second connection member 65 is provided, in the wedge portion 68, with a plurality of axial cuts or slots (shown in dashed outline as 68a) which serve the same function as the cuts or slots in the first connection member 15 as described below.

FIG. 5A shows a second connection member 65 with the wedge portion 68 formed as a nose 69 with bevelled or rounded or extended surfaces 68b which assists in moving the upstanding wall portion 18 of the first connection member 15 upward, as schematically indicated in FIGS. 7A to 7D, 9 and 10 (not to scale though showing the same second connection member 65), though may also assist in accommodation of the wedge portion 68 within the space 70 between the flat portion 17 of the first connection member 15 and the inner surface 41 of the sleeve 40. Extended wedge portion 68 provides a flexible low modulus area in the joint 200 to accommodate movement of the pipe sections 10, 60 within the sleeve 40 without failure of the adhesive interface on the sleeve lock.

An alternative second connection member 15 may be provided with a wedge portion 68 of the form shown in FIG. 5B. This second connection member has a wedge portion 68 of lesser length than FIG. 5B though may also be provided with a bevelled, chamfered or rounded end to assist its accommodation within space 70. Either the second connection member 15 of FIG. 5A or FIG. 5B may be used in embodiments of the invention.

The second pipe section 60 is then moved, indeed forced under substantial compression, toward the first assembly 135 such that the wedge portion 68 of the second connection member 65 moves into the annular space 70 to occupy—with the desired alignment of pipe sections 10 and 60—the space 70 as shown in FIGS. 7A to 7D. Axial cuts and slots in wedge portion 68a assist this process by helping the ‘feet’ between the axial cuts and slots 68a of the wedge portion 68 to flex or ‘squirm’ into the annular space 70. If the axial cuts and slots 68a were not provided, the significant forces involved during movement of the second connection member 65 could cause it to rip or tear, the resulting joint-if even achieved-being unacceptable.

The second pipe section 60 is then joined to the first assembly 135, by bonding with the adhesive previously injected throughout annular space 70, to form a joint 200 in which the first and second pipe sections 10 and 60 are connected to the sleeve 40. Again, as with the first pipe section 10, a surface 46 of the sleeve 40, being the area of connection with the second pipe section 60, has been covered by peel ply to protect it but it may be scuffed or roughened to improve adhesive adhesion at surface 46. This may be done at the same time as scuffing of surface 44. Such scuffing is milder than, and to be contrasted with, a grinding process as formerly used. It may also be necessary to treat the surface 44 to remove residual release or blocking agent.

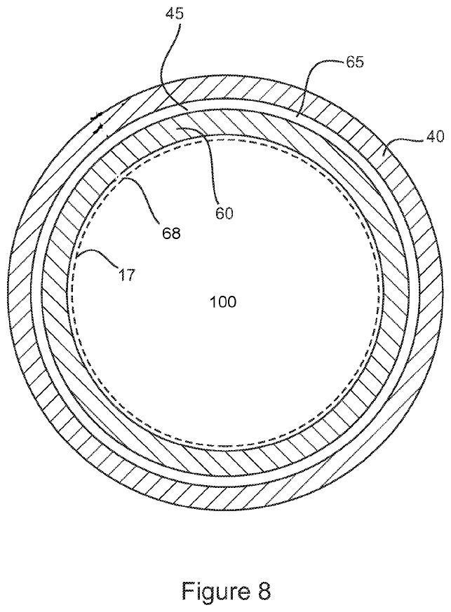

An important element of the joint 200, providing integrity against leakage, is joining of the first and second connection members 15 and 65 which, as described above have complementary geometry. The flat portion 17 of first connection member 15 extends outward from the first pipe section 10. The flat portion 17 leaves an annular space 70 between the inner surface 41 of the sleeve 40 and the flat portion 17. Annular space 70 has complementary geometry with the part cylindrically shaped wedge portion 68 of second connecting member 65 which is accommodated by the space 70. As the second pipe section 60 is forced into space 70, the wedge portion 68 and wall portion 18 together act as a piston pressurising the adhesive and forcing it under pressure against the end wall 19 of first connection member 15 and of space 70 (i.e. the cylinder) which assists bonding with an effect analogous to the operation of a ‘submarine hatch’. This process is schematically shown in FIGS. 7B and 7D with the final joining—with wall portion 18 forced from an acute angle disposition (as shown in FIGS. 7A, 7B and 7D) to lip 17 to a vertical disposition as shown in FIG. 7C where it is bonded to both end wall 19 of first connection member 15 and end wall 69 of second connection member 65. At this point in time, pipe sections 10 and 60 are in joining relation with an end view for this event being FIG. 8.

As described above, first connection member 15 and second connection member 65 are provided with a series of axial cuts or slots 15a and 68a. Axial cuts or slots 68a of second connection member 65 serve a first function as already described. The axial cuts and slots 15a, 68a also serve the function of allowing adhesive to flow axially away from the joint interface formed at wall portions 19, 18 and 69 to flow into space 45 between sleeve 40 and along outer surfaces of pipe sections 10 and 60. As these slots axial cuts or slots 68a are subject to compression during the joining step described below and may constrict, a dimension for the axial cuts and slots 68a is selected to minimise blocking and flow of adhesive which would be undesirable. For example, the cuts or slots 15a, 68a may be a few millimetres wide though this will depend on the selected pipe 10 diameter. Upstanding wall portion 18 of first connection member 15 also assists in this process by, when being moved upward by wedge portion 68, forcing adhesive radially outward and away from the joint interface into the axial cuts or slots 15a, 68a. The flat portion 17 and upstanding wall portion 18 of the first connection member co-operate with the inner surface of the wedge portion 68 of the second connection member 65 to distribute adhesive axially (along the outer surfaces of pipe sections 10 and 60) and radially outward such that adhesive is either absent or substantially absent from the inner wall of the pipe sections 10 and 60 at the joint 200.

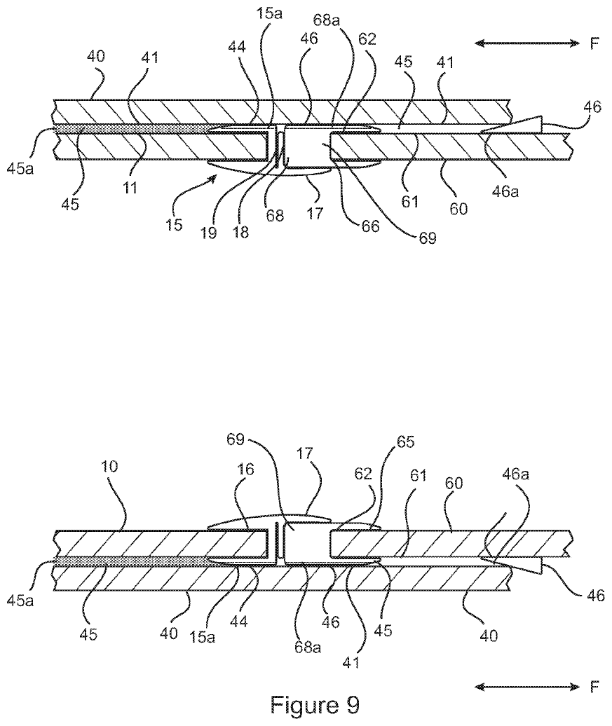

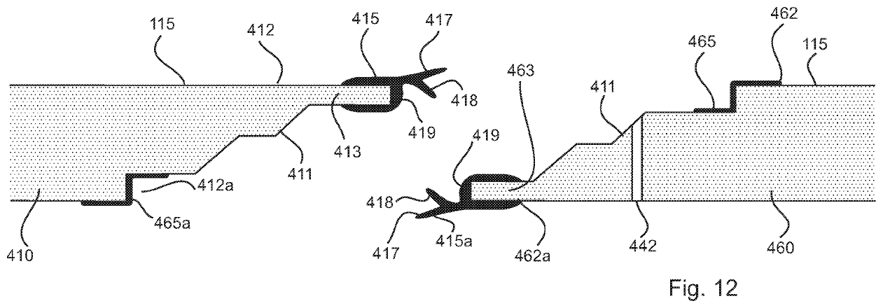

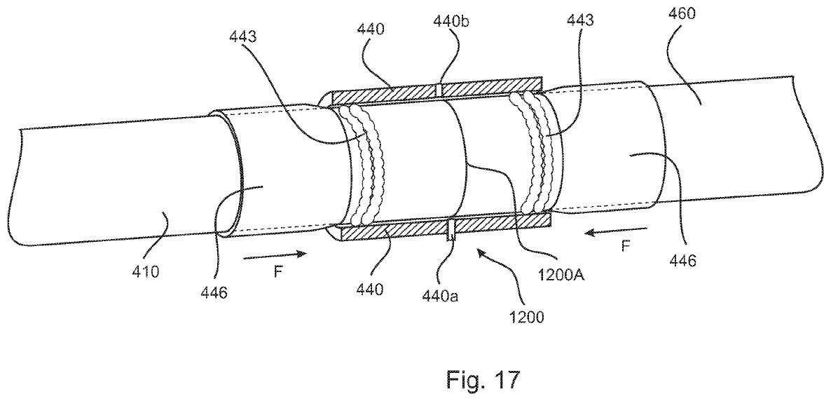

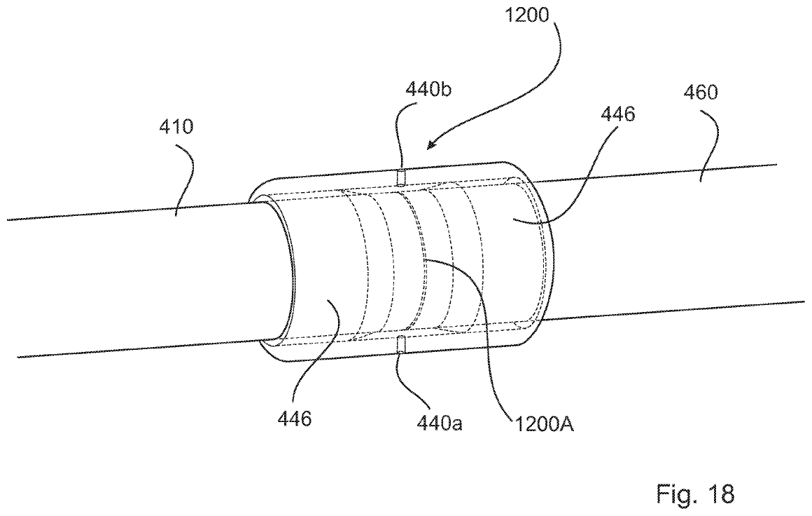

As to connection of the sleeve 40 to each pipe section 10 and 60, this step conveniently proceeds as follows. As described above, there is a space 45 between the respective outer surfaces 11, 61 of each pipe section 10, 60 and the inner surface 41 of the sleeve 40 as shown, for example, in FIG. 9. A spacer or wedge 46, 46A is, in an embodiment, fitted into this space 45 to close—with an optional exception as described below—an opening 45c to the space 45 between an end 48 of the sleeve 40 and each of the first and second pipe sections 10 and 60 and mechanically lock the sleeve 40 and pipe sections 10 and 60 together while leaving space 45 with a substantially uniform dimension between pipe section 10, 60 and sleeve 40. Each wedge 46, 46A is also a flexible rubber extrusion or fiberglass pipe section of the required length ground with a chamfered edge with an aerofoil shape, as shown in FIG. 6A that has sufficient dimension, on compression, to fit within the space 45, with the narrow edge facilitating this process. FIG. 6B shows an extended thin form wedge 446 which is chamfered at on end 446a. This greater length of wedge 446 reduces the space between the wedges and adhesive required and may be used alternatively to the wedge 46 in embodiments of the invention as in the case of the embodiment described with reference to FIGS. 12 to 18.

As with the first and second connection members 15 and 50, a degree of flexibility of the wedges 46, 46A may facilitate assembly. However, excessive flexibility of wedges 46, 46A may allow twisting during assembly and this is undesirable as it may prevent a lock liner to lock liner joint—in which inner layers 115 of each pipe section 10, 60 as schematically shown in FIG. 1 are joined together.

Heating of an extrusion forming wedge 46 may be done to assist forming into the approximate circular shape of the pipe sections 10 and 60.

One spacer or wedge 46, 46A is here provided to close each of the pair of openings 45c to the space 45 between the first pipe section 10 and the sleeve 40. Another spacer or wedge 46A is provided to close the opening 45c to the space 45 between the second pipe section 60 and the sleeve 40. The narrow end 46a of each wedge 46, 46A is fitted into each opening 45c to the space 45 as shown in FIGS. 2, 9 and 10. Fitting of wedges 46 and 46A into position is assisted by chamfering the ends 40a of sleeve 40 to provide chamfered surfaces 46d conveniently having the same slope as the top surface of wedges 46, 46A.

In an alternative embodiment, wedges could be formed integrally with sleeve 40 and pipe sections 10 and 60 or disposed upon the pipe sections as described with reference to FIGS. 12 to 18 below. In preferred embodiments, wedge 46 is fitted in the factory as part of connecting first assembly 135 to sleeve 40.

Though the first and second connection members 15 and 65 could possibly allow an interference fit, connection in this embodiment involves adhesion of the first and second connection means 15 and 65 through use of a suitable adhesive or primer, for example a vinyl ester resin acrylic urethane adhesive as employed for the fast bonding of automotive assemblies as made by Henkel®, Plexus® or Sika®, which is applied to the first connection member 15 prior to moving the second pipe section 60 towards the first assembly 135. If the above-mentioned Teflon rings are used, these are also removed prior to the moving and injection steps.

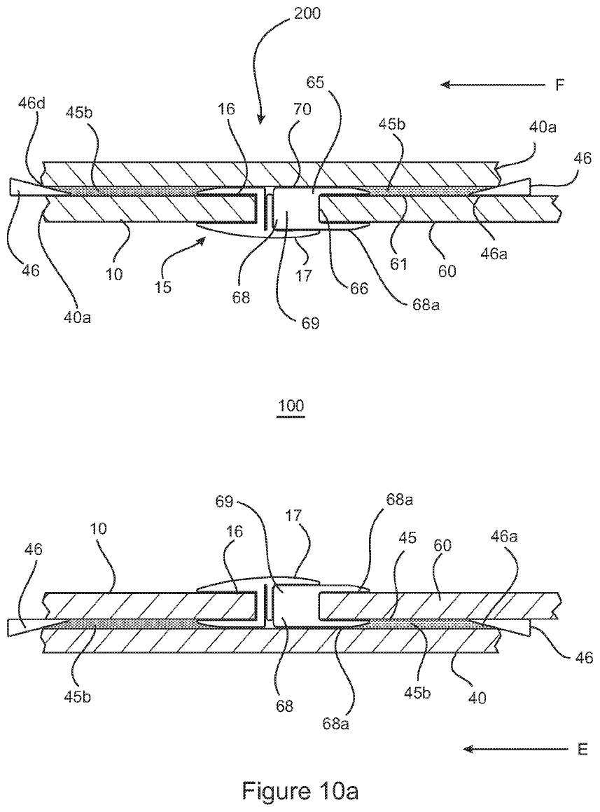

As described above, moving the second pipe section 60 into the first assembly 135 involves compression of the second pipe section 60 towards the first assembly 135—conveniently in embodiments mounted on a stand—in the direction of arrow F illustrating compressive force as shown in FIG. 10. A clamping mechanism (not shown), for example a manual or machine adjustable strap tensioner arrangement which wraps around the pipe sections 10, 60 and presses the components of the joint (these comprising sleeve 40, connection members 15 and 65, pipe sections 10 and 60 and wedge 46—wedge 46A has already been fitted in this preferred embodiment) into position, is used for this purpose. Compression force F—which must be controlled for example by operating winch(es) to optimise the process of alignment and pressing the various components of the joint 200 together—assists in locking the wedge 46A into to close off the remaining opening 45c to the space 45 so completing the joint 200 of the two pipe sections 10 and 60. It may be necessary to deploy a ring to hold wedge 46A in position as compression proceeds. This ring may through a suitable mechanism, such as screw jacks-enable controllable compression over wedge 46A for this purpose. The use of ring and screw jacks may also be used—as necessary—during fitting of wedge 46 following connection of sleeve 40 and first assembly 135 as described above. Curing time, in some embodiments, is 10 to 30 minutes following joining of first and second pipe sections 10 and 60 by joint 200. In this way, the sleeve 40 and the wedge 46A act as an alignment tool to align and lock the joint 200 into position.

No post curing of the joint 200 should be required though heating of the ends 12 and 62 of pipe sections 10 and 60 may be conducted to assist the assembly operation if needed. However, in extremely cold conditions, it may be necessary to heat the adhesive before injection and the pipe/sleeve assembly once injected.

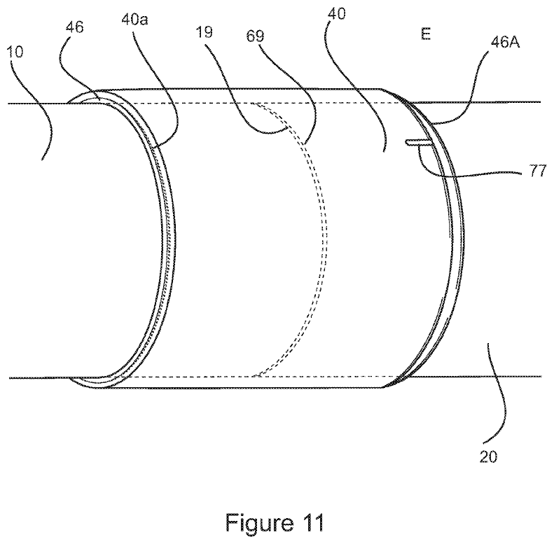

Though the space 45, between the inner surface 41 of sleeve 40 and the outer surfaces 11 and 61 of pipe sections 10 and 60, is substantially closed off by the wedge 46A, as shown in FIG. 10. In this embodiment an outlet 77, as shown in FIG. 11, is left between the space 45, as enclosed by wedge 46A, and exterior E. Each wedge 46, 46A may also be selected to be of a length, less than the circumference of each of first and second pipe sections 10 and 60 which leaves a gap to serve as the outlet 77.

However where very large heavy pipes are being joined the fiberglass wedge may be formed from a split pipe made using the same process as set out in the applicant's other patents and incorporated herein.

The sealing and adhesive material 45b, which completes a gas-tight seal of the joint 200 whilst also providing it with structural strength, is then injected into the space 45 of substantially uniform dimension to assist its consistent filling with the sealing and adhesive material 45b, as schematically illustrated by FIG. 10. The sealing and adhesive material 45b is desirably a composite material, for example a Kevlar pulp to which fibreglass or other fibres and a thickening agent—such as fumed silica and available under the registered trade mark Cab-O-Sil of Cabot Corporation—are added to reduce propensity for flow of the Kevlar pulp prior to curing. In this case, the sealing and adhesive material 45b is conveniently a two phase or multi-phase composition including a low viscosity adhesive portion which may be formed by the liquid fraction of the Kevlar pulp and another adhesive.

It will be understood that other sealing materials or adhesives may be used subject to the requirements of suitability for sealing and provision of structural strength. In the latter respect, inclusion of a fibre rich material is highly advantageous because, when filling the annular space 45, the bridging of fibres creates a fibre bond across the annular space 45.

The sleeve 40 is provided with injection port(s) (not shown), at a distance of, for example 100 mm, from the contacting faces (including wall portion 18 and end walls 19 and 69) of connection members 15 and 65, for example by drilling holes into the sleeve 40, to enable injection under pressure of the sealing material 45b into the annular space 45. Such drilling may be performed during fabrication of the sleeve 40. An injection port is here provided on the first pipe section 10 side of the joint 200 and another injection port is provided on the second pipe section 60 side of the joint 200. As the annular space 45 fills from the bottom up with sealing material 45b, some sealing material 45b is forced through the outlet(s) 77 indicating that filling is complete. This results from the injection pressure being sufficient to provide a positive pressure inside the annular space 45 to ensure that air pockets which could create leak paths, if present, are forced out of the annular space 45 once completely filled with sealing and adhesive material 45b. A straw, such as of plastic or paper material soluble in the sealing and adhesive material 45b, or to be removed once filling is completed and all air released, may be included to facilitate release of air trapped in a top section of the annular space 45 and enable the sealing and adhesive material 45b to packed into place. In this regard, the wedges 46, 46A are sized so as to leave an outlet 77 and the straw can extend into this outlet 77. In some embodiments, curing time of a few hours should be allowed. Though wedge 46 has been fitted earlier, as described above and schematically shown in FIG. 2, the principles concerning injection and sealing and adhesive material 45b as above described with reference to wedge 46A and injection of sealing and adhesive material 45a into the space 45 are equally applicable to fitting of wedge 46.

Following a few hours curing, the clamping mechanism may be removed. The joined pipe sections 10 and 60 are now ready for use and could, for example be dropped into a trench, for example being 150 to 1,500 metres long.

A further embodiment of the method for joining pipe sections is now described with reference to FIGS. 12 to 18. Although the principles of the joining method are similar, the further embodiment would typically be applied to thick pipe sections comprising a large number of layers (more than 5 or even 10 layers or more of e.g. 10-20 mm thickness) including the inner liner 115. Such pipe sections 410 and 460 are fabricated as described above and are cut to length but there are some differences in the joining process.

First, it is typically necessary with thick wall sections to grind a chamfer or series of steps 411 on the ends of each of the pipe sections 410 and 460 to be joined as shown in FIGS. 12 and 14. Such a series of steps 411—which need not extend through the entire thickness of the pipe section 410 and 460—may be ground using techniques known in the art and might extend around 5 layers of a pipe section 410, 460 allowing for a ten layer plus laminate pipe section. The grinding process leaves an extended portion or edge of pipe section 410. The grinding also provides a space or path, desirably of substantially uniform dimension, for the injection of adhesive.

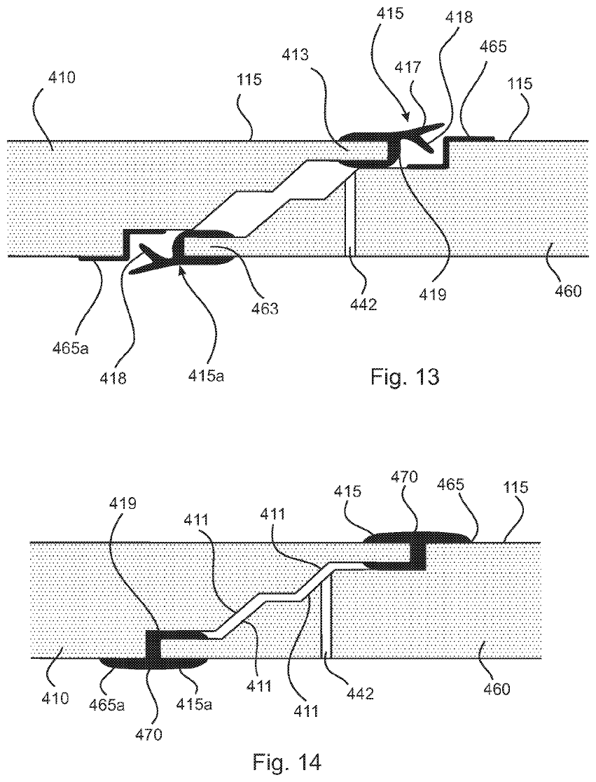

Second, as shown in FIGS. 12 and 13, a first connecting member 415 is fitted and adhered to an inner edge 412 of pipe section 410. First connecting member 415 is an extrusion having a similar configuration to first connecting member 15 having a slot 416 with an end wall 419 for engagement with the edge formed by pipe section end 412 and a flat portion 417 with a wall portion 418 extending in a direction away from the direction of the slot 416. Flat portion 17 has an upstanding wall portion 418.

Third, a second connecting member 465 is fitted and adhered to an inner edge 462 of pipe section 460. Though also an extrusion, second connecting member 465 has a different configuration than second connecting member 65 having no wedge. Second connecting member 465 rather fits on to the cut edge of pipe section 460.

Fourth, a further first connecting member 415a—the same in configuration as connecting member 415—is fitted and adhered to an outer edge 462a of pipe section 460.

Fifth, a second connecting member 465a—the same in configuration as second connecting member 465—is fitted and adhered to the outer edge 412a of pipe section 410.

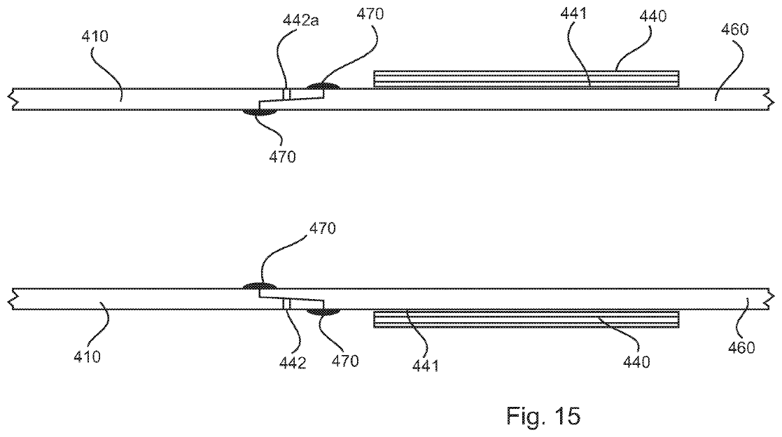

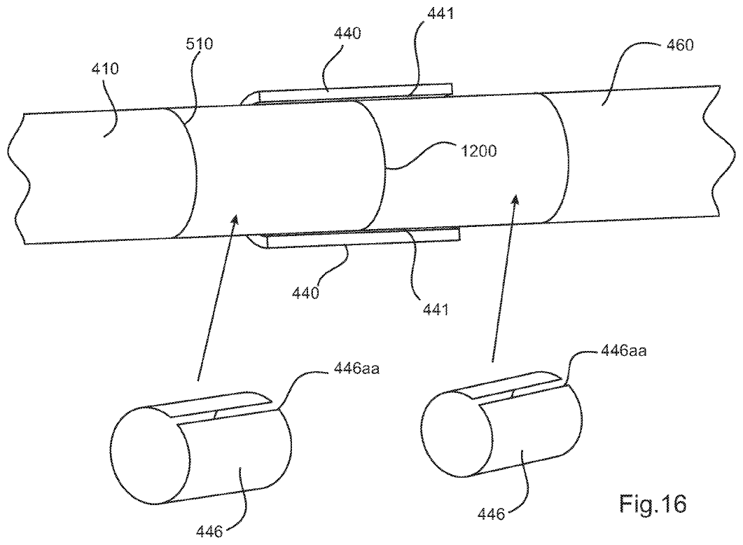

Sixth, the first and second connecting members 415, 415a, 465 and 465a are covered with adhesive and the pipe sections 410 and 460 are pulled together under tension (using suitable tensioners (not shown) to join the first and second connecting members 415, 415a, 465 and 465a at junctions 470 as shown in FIGS. 14 and 15. These junctions 470, formed in the same manner as described for previous embodiments, form part of an interface of joint 1200 as indicated in FIGS. 15 and 16. As apparent from FIGS. 12 to 15, this interface is not formed in a single plane, rather having a ‘zig zag’ configuration which provides a greater surface area for bonding. The adhesive is allowed to cure.

Seventh, if not done previously, a hole 442 is drilled into second pipe section 460 as shown in FIGS. 12 to 15. FIGS. 12 to 14 show one side of the pipe sections 410 and 460. However, a corresponding hole 442a is also drilled into second pipe section on its other side as shown in FIG. 15. In this embodiment, holes 442 and 442a are shown in alignment. However, while convenient, such alignment of holes 442 and 442a is not required. Further, the holes 442 and 442a could be arranged on either or both of pipe sections 410 and 460. Hole 442 is provided for the injection of adhesive which allows the pipe sections 410 to 460 to be bonded together, though not typically with the required strength which requires further steps as described below. Hole 442a allows for excess adhesive to flow through the space between the pipe section ends 412, 462 to ensure filling of the space with adhesive and completion of the preliminary stage of joining pipe sections 410, 460. Hole 442 is sealed and the adhesive is allowed to cure.

As shown in FIG. 15, a sleeve 440—fabricated in the same manner as sleeve 40 earlier described and having a slightly greater inner diameter than the outer diameter of pipe sections 410 and 460 thus leaving a space 441—is disposed by sliding onto second pipe section 460. Sleeve 440 is, at this point, able to slide along second pipe section 460 and over the interface between pipe sections 410 and 460. The sleeve 440 is positioned over the interface such that the interface is conveniently mid way along the sleeve 440 and held in position. At this point space 441 is still open at both ends of the sleeve 440.

Adhesive is injected through the openings of the annular space 441 at both ends of the sleeve to form a pair of annular or cylindrical walls of adhesive within space 441.

Further, as shown in FIG. 16, the extended thin wedges 446, conveniently of fibreglass, are disposed on each side of sleeve 440. The extended thin wedges 446 do not, in this embodiment, extend all the way around the circumference of pipe sections 410 and 460, rather having a slot 446aa. which are loosely fitted into the space 441 between the outer wall of the pipe sections 410 and 460 and the inner wall of the sleeve 440, the chamfered ends 446a of wedges 446 facilitating this process slots 446aa are blocked with Teflon plugs (not shown).

The wedges 446 are forced as far as possible, dependent on the substantial compression force exerted, conveniently by screw jacks, into the space 441 and into the walls of adhesive forcing an adhesive wall in front of each wedge 446. Due to the configuration of the wedges 446, the pipe sections 410 and 460 are centralised within the space 441 which is caused to be of substantially annular shape with dimension of approximately the thickest dimension of wedges 446.

The wedges 446 when forced by compression, conveniently by screw jacks, into position together extend substantially the whole length of sleeve 440. The adhesive, from the initial walls of adhesive, provide a mechanical lock between the sleeve 440 and pipe sections 410 and 460 when cured. The plugs are removed from slots 446aa of the wedges.

The sleeve 440 is also drilled with at least one (bottom) injection hole 440a and a further hole acting as a vent 440b. Adhesive and sealing material is injected under pressure into the space 441 above the joint 1200 through bottom injection hole 440a following the same process as described above with reference to FIG. 10. Vent 440b may be fitted with a plug or bung to ensure positive pressure of adhesive is achieved in space 441. Completion of pressurised filling of, and expulsion of air from, space 441—with the object of eliminating leak paths and air bubbles or pockets—is indicated by a small flow of adhesive and sealing material from vent 440b. If desired, and as described in relation to the previous embodiment, a straw can be located in vent 440b and this straw may be of material that dissolves in the sealing and adhesive material. At the end of this step, the injection hole(s) 440a and vent 440b should also be sealed.

During the injection of sealing and adhesive material into space 441, the gaps provided by removal of plugs from slots 446aa of the wedges 446 also provide vents for release of air.

In embodiments, and to reduce jointing time, the space 441 could be injected with adhesive and sealing material during the compression process. In this case, it may be necessary to seal vent 440b with a plug or blank to prevent adhesive being driven out of the space simply because of the compression and moving step.

In some embodiments, curing time of a few hours should be allowed to complete fabrication of joint 1200. The screw jacks, jigs and tensioners are removed at the end of the curing period.

The order of steps provided above is a convenient way to join the pipe sections 410 and 460 but the order of the steps, in particular the initial several steps, may be changed in order at the fabricator's convenience.

No post curing of the joint 200 should be required though heating of the ends 12 and 62 of pipe sections 10 and 60 may be conducted to assist the assembly operation if needed. However, in extremely cold conditions, it may be necessary to heat the adhesive before injection and the pipe/sleeve assembly once injected.

The strength at the joint 1200 is substantial. At an estimated 45 bar burst pressure threshold per layer of laminate pipe sections 410 and 460, burst pressure would be estimated at 450 barg for a joint of ten layer laminate pipe sections 410 and 460 and at 900 barg for a joint of twenty layer laminate pipe sections.

These sections or strings, of either embodiment, could now be joined in the trench by excavating a crosscut of sufficient size and depth to allow operators to join long strings together in the trench using the same approach as each small section of pipe has been joined.

An advantage of the above method, joint and apparatus for joining pipe sections is that locked liner to locked liner joints, which ensure that only the liner is in contact with the materials being transported, may be achieved using steps expected to be reproducible using jig or assembly steps on a continuous assembly line, for example using a pipe production machine similar to that described in International Patent Publications WO 2017/205927 and WO 2017/205928, the contents of which are incorporated herein by reference for all purposes. The inner liner 115 is the inner layer of the radially inner portion of each pipe section and presents a surface for the fluid passing through the joined pipe sections 10 and 60. At the same time, the method is quicker (potentially less than 2 minutes per joint), easier and safer to perform without difficult precision work being required by personnel forming the joints. This may enable less requirement for specialised labour when joining pipe sections together.

A joint 200, 1200 made as described above is intended to be strong. The joints 200 and 1200 are designed to seal better the more pressure that is put on to it while not acting as a stress concentration point because the sleeve 40 can flex with the pipe sections 10 and 60 without kinking. Force is distributed over the joint with load transfer being even as the joint transfers axial load across the joint and transfers the load into a shear load through the lightweight structure arising from the polymeric nature of the sleeves and pipes. The rubber extrusions which are respective first and second connecting members 15, 65, 415, 415a, 465 and 465a enable the joint to have a pre compressed flexibility to enable loads and movement to be taken by the joint without loss of seal or integrity.

Pipe networks, including pipe sections connected together by joints 200 as described above, may be effectively applied to transport of carbon dioxide (including in wet state) and hydrogen including as part of ammonia production.

Modifications and variations to the method and apparatus for joining hollow structures as described in the specification may be apparent to the skilled reader of this disclosure. For example, the first and second pipe sections may have the same or different geometry. The terms “first” and “second” may be used interchangeably. Each pipe section may comprise a length of pipe or a fitting, such as a T or elbow. The method may, subject to thickness of the vessel wall, be applied to construction of vessels, for example to join end domes of a process or pressure vessel to other sections of the process vessel.

Throughout this specification, unless the context requires otherwise, the word “comprise” or variations such as “comprises” or “comprising”, will be understood to imply the inclusion of a stated integer or group of integers but not the exclusion of any other integer or group of integers.

The method steps, processes, and operations described herein are not to be construed as necessarily requiring their performance in the particular order discussed or illustrated, unless specifically identified as an order of performance. It is also to be understood that additional or alternative steps may be employed.

1. A method for joining two pipe sections of laminate structure, comprising the steps of:
(a) connecting a first pipe section having an inner liner to a first connection member to form a first assembly;
(b) disposing the first assembly within a sleeve with a space disposed between an outer surface of the first pipe section and an inner surface of the sleeve;
(c) optionally connecting the sleeve to the first assembly;
(d) providing a second pipe section having an inner liner with a second connection member joinable with the first connection member;
(e) moving the second pipe section and first assembly towards each other; and
(f) connecting the second pipe section to the first assembly through joining the second connection member to the first connection member to form a joint in which the first and second pipe sections are connected to each other and the sleeve, the inner liner of both the first and second pipe sections being locked within the joint.

2. The method of claim 1, wherein disposing the first assembly within the sleeve in step (b) comprises sliding the first pipe section inside the sleeve and moving step (e) involves sliding the second pipe section into the first assembly.

3. (canceled)

4. The method of claim 2, wherein connection between sleeve and first assembly is by bonding or adhesion and connection is made between the first connection member and the sleeve.

5.-7. (canceled)

8. The method of claim 1, wherein said first and second connection members are flexible to allow flexing to fit to the respective pipe sections.

9. The method of claim 1, wherein, when positioned and connected to the respective first and second pipe sections, the respective first and second connection members protect the pipe section ends at the joint, the first and second connection members locking the liner into the joint.

10.-11. (canceled)

12. The method of claim 1, wherein said first connecting member has a flat portion which-when the first connecting member is connected to the first pipe section-extends outward from the first pipe section, an annular space being disposed between an inner surface of the sleeve and the flat portion.

13. The method of claim 12, wherein the flat portion is rippled or corrugated to provide flexibility for the flat portion.

14. The method of claim 13, wherein the flat portion is provided with an upstanding wall portion extending outward from the flat portion, optionally at an acute angle to the flat portion.

15. The method of claim 14, wherein the upstanding wall portion is flexible and movable upward by the second connection member when acting against it as a piston.

16. The method of claim 15, wherein the second connection member has a geometry that allows jointing with the first connection member through accommodation of at least a portion of the second connection member within the space disposed between the inner surface of the sleeve and the flat portion.

17. (canceled)

18. The method of claim 12, wherein the second connection member is provided with a single wedge portion to fit within the space disposed between the inner surface of the sleeve and said flat portion.

19. (canceled)

20. The method of claim 18, wherein each of the first and second connection members are provided with cuts or slots forming feet which flex during forming of the joint to distribute adhesive axially, along the outer surface of the pipe sections, into the space disposed between the inner surface of the sleeve and the outer surfaces of the pipe sections and away from the inside of the pipe sections.

21. (canceled)

22. The method of claim 2, wherein the flat portion and the upstanding wall portion of the first connection member co-operate with a wedge portion of the second connection member to distribute adhesive away from the inside surfaces of the pipe sections.

23.-24. (canceled)

25. The method of claim 12, wherein the first connection member, when connected to the first pipe section in step (a), is configured to enable the second pipe section to be centralised or aligned co-centrically with the sleeve through location of the second connection member and its associated second pipe section in the space disposed between the flat portion of the first connection member and the sleeve.

26. The method of claim 17, wherein the sleeve is connected to each of the first and second pipe sections, by insertion into the annular space between the outer surface of each pipe section and the inner surface of the sleeve of a wedge fitted into said space to close an opening to the space between an end of the sleeve and each of the first and second pipe sections, one wedge being provided to close the opening to the space between the first pipe section and the sleeve and another wedge being provided for fitting to close the opening to the space between the second pipe section and the sleeve resulting in an enclosed space.

27.-34. (canceled)

35. The method of claim 12, including a step (g) of substantially filling the enclosed annular space between the sleeve and first and second pipe sections with a sealing and adhesive material.

36. The method of claim 35, wherein the enclosed space between inner surface of the first pipe section and inner surface of the sleeve is filled with sealing and adhesive material prior to jointing of the first and second pipe sections.

37. The method of claim 36, wherein an outlet is left between the enclosed space and exterior for air to be expelled from the otherwise enclosed space during step (g).

38. The method of claim 37, wherein a wedge has a length which leaves a gap, when the wedge is fitted into the space.

39. The method of claim 36, wherein the sleeve is provided with injection port(s) to enable injection of the sealing and adhesive material, an injection port being provided on the first pipe section side of the joint and another injection port being provided on the second pipe section of the joint, each injection port being located at a distance from the joint interface.

40. (canceled)

41. A pipe constructed according to the method of claim 1.

42. (canceled)

43. A joint between two pipe sections of laminate structure, the joint comprising:
(a) a first joint portion comprising a first pipe section with an inner liner connected to a first connection member, said first joint portion being disposed within a sleeve with a space disposed between an outer surface of the first pipe section and an inner surface of the sleeve, the sleeve being connected to the first pipe section; and
(b) a second joint portion comprising a second pipe section with an inner liner with a second connection member joined to the first connection member at a joint interface and first pipe section, a space also being disposed between an outer surface of the second pipe section and an inner surface of the sleeve, the sleeve being connected to the second pipe section wherein the inner liner of the first and second pipe sections is locked within the joint.

44. The joint of claim 43, wherein, following enclosure of the space between the sleeve, first and second pipe sections by wedges, the enclosed space is substantially filled with a sealing and adhesive material.

45. An apparatus for joining two pipe sections of laminate structure, comprising:
(a) means for connecting a first pipe section having an inner liner to a first connection member;
(b) means for disposing a first assembly comprising the first pipe section connected to said first connection member within a sleeve with a space disposed between an outer surface of the first pipe section and an inner surface of the sleeve;
(c) optional means for connecting the sleeve to the first pipe section;
(d) means for providing a second pipe section having an inner liner with a second connection member joinable with the first connection member;
(e) compression means for moving the second pipe section and first assembly towards each other such that the second connection member joins with the first connection member;
(f) means for joining the second pipe section to the first assembly to form a joint in which the first and second pipe sections are connected to the sleeve, under compression, the inner liner of both the first and second pipe sections being locked within the joint; and
(g) an injection means for filling a space between the sleeve and a pipe section at the joint with a sealing and adhesive material.

46. (canceled)
